(19) United States
(12) Patent Application Publication
(10) Pub. No.: US 2009/0228745 A1
(43) Pub. Date: Sep. 10, 2009

(54) ERROR BACKUP METHOD

(75) Inventors: Akihisa Sota, Kawasaki (JP); Yoshiyuki Tokumitsu, Kahoku (JP); Yuzi Fukuoka, Kahoku (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/397,736

(22) Filed: Mar. 4, 2009

(30) Foreign Application Priority Data
Mar. 10, 2008 (JP) 2008-059183

(51) Int. Cl. G06F 11/07

(52) U.S. Cl. 714/57; 714/E11.025

(57) ABSTRACT

A control method for controlling an information processing device including a first processor, a second processor, and a plurality of devices, including the steps of: detecting an error of at least one device of the plurality of devices by the first processor; storing an error log related to the detected error in the devices in a memory by the first processor; when failing in store the error log in the memory, storing the error log in an auxiliary memory by the second processor.

### CROSS-REFERENCE TO RELATED APPLICATION

This application is based upon and claims the benefit of priority of the prior Japanese Patent Application No. 2008-059183 filed on Mar. 10, 2008, the entire contents of which are incorporated herein by reference.

### FIELD

A certain aspect of the embodiments discussed herein is related to a method for storing an error log of an information processing device.

### BACKGROUND

In recent years, with an increase in size of an information processing device such as a server, types of integrated circuit (IC) and the number of integrated circuits (IC) mounted on the information processing device have been increasing.

FIG. 1 is a block diagram that shows an example of an existing information processing device. The information processing device 1 shown in FIG. 1 is connected to an external device 3 through external interfaces (I/Fs) 2, and forms portion of a storage system. The external device 3 is, for example, a host device or a storage device. When the external device 3 has the same structure as the information processing device 1, a multiplexed storage system is constructed.

The information processing device 1 includes a processor 11, a bridge circuit 12, a memory 13, large scale integrated circuits (LSI) 14-1 to 14-M, switch circuits 15-1 to 15-N, data buses 16 and 17, a sideband I/F 18, and an internal I/F 19, which are connected as shown in FIG. 1. M and N may be either M=N or M≠N. M is natural number excluding 0 and N is natural number excluding 0.

As shown in FIG. 1, F1 indicates an abnormality that occurs in the data bus 16 between the processor 11 and the bridge circuit 12, and F2 indicates an abnormality that occurs in the data bus 17 between the bridge circuit 12 and the LSI 14-1. As in the case of the abnormality F1 or F2, when an error that influences the main data buses 16 and/or 17 connected to the processor 11 occurs, it is difficult for the processor 11 to acquire error factor information of all device portions in the information processing device 1 using the data buses 16 and/or 17. In such a case, it is less likely that an error log remains in the memory 13 and, therefore, it is difficult to isolate error factors.

On the other hand, when an error occurs in the data bus 16 or 17, access to the LSIs 14-1 to 14-M by the processor 11 using the data bus in which an error has occurred requires a bus reset. However, the bus reset may reset error information, or the like, in the LSIs 14-1 to 14-M. For this reason, if the processor 11 accesses the LSIs 14-1 to 14-M after bus reset, error information may not be acquired.

Japanese Laid-open Patent Publication No. 8-305641 suggests an example of a bus control device that prevents a system stop due to a failure of a single portion. Furthermore, Japanese Laid-open Patent Publication No. 2006-65709 suggests an example of a data processing system that implements the function of a multifunctional and high-performance storage system in a low-cost storage system.

In an existing information processing device, when an error occurs due to an abnormality of a main data bus connected to the processor, there has been a problem that it is difficult to isolate error factors without collected error conditions.

### SUMMARY

According to an aspect of an embodiment, a control method for controlling an information processing device includes a first processor, a second processor, and a plurality of devices, including the steps of: detecting an error of at least one device of the plurality of devices by the first processor; storing an error log related to the detected error in the devices in a memory by the first processor; when failing in store the error log in the memory, storing the error log in an auxiliary memory by the second processor.

The object and advantages of the invention will be realized and attained by means of the elements and combinations particularly pointed out in the claims.

It is to be understood that both the forgoing general description and the following detailed description are exemplary and explanatory and are not respective of the invention, as claimed.

### BRIEF DESCRIPTION OF THE DRAWINGS

FIG. 1 is a block diagram that shows an example of an existing information processing device;

FIG. 2 is a block diagram that shows a first embodiment of the invention;

FIG. 3 is a flowchart that illustrates the operation of a support processor according to the first embodiment;

FIG. 4 is a time chart that illustrates the operation of the first embodiment;

FIG. 5 is a block diagram that shows a second embodiment of the invention; and

FIG. 6 is a block diagram that shows a third embodiment of the invention.

### DESCRIPTION OF EMBODIMENTS

When an information processing device that includes first and second processors and a plurality of devices, the first processor detects an abnormality among the devices that are connected to the first processor through a first bus. As the first processor detects an abnormality, the first processor provides an abnormality notification to the second processor that is connected to the first processor through a second bus. The second processor acquires an error log through the second bus on the basis of the abnormality notification.

By so doing, even when an error occurs due to an abnormality of the first bus, or the like, connected to the first processor, it is possible to isolate error factors by reliably collecting error conditions.

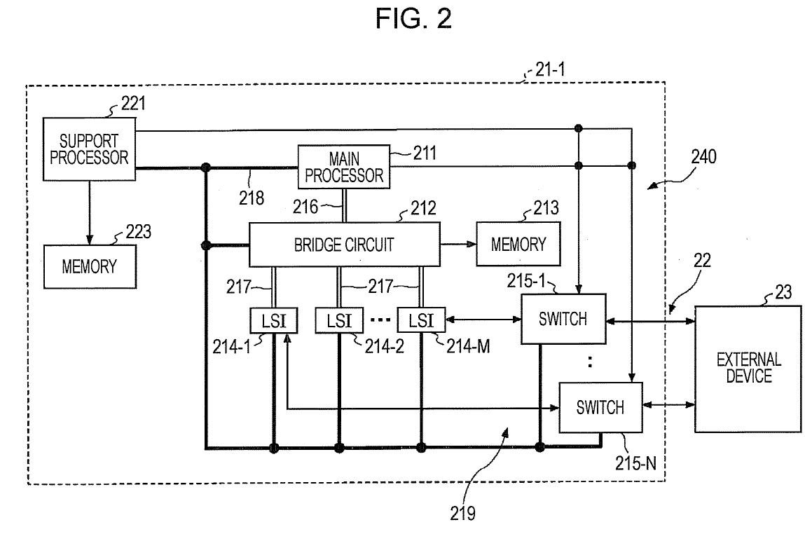

Hereinafter, embodiments of a control method, information processing device and storage system according to the aspects of the invention will be described with reference to FIG. 2 to FIG. 6.

### First Embodiment

FIG. 2 is a block diagram that shows a first embodiment of the invention. An information processing device 21-1 shown in FIG. 2 is connected to an external device 23 through external interfaces 22 or external buses 22. The external device 23 is, for example, a host device or a storage device. When the external device 23 has the same configuration as the information processing device 21-1, a multiplexed storage system may be constructed of the information processing device 21-1 and the external device 23. The information processing device 21-1 may be configured to form a storage system by the information processing device 21-1 itself or may be configured to form portion of a storage system.

The information processing device 21-1 includes a main processor 211, a bridge circuit 212, a memory 213, large scale integrated circuits 214-1 to 214-M, switch circuits 215-1 to 215-N, data buses 216 and 217, a sideband I/F or a sideband bus 218, an internal I/F or an internal bus 219, a support processor 221, a memory 223 and a control line 240, which are connected as shown in FIG. 2. M is natural number excluding 0 and N is natural number excluding 0. The main processor 211 and the support processor 221 both may be implemented by a general-purpose processor. M and N may be either M=N or M≠N.

The main processor 211 controls the operation of the entire information processing device 21-1. When the information processing device 21-1 constitutes a storage system, the main processor 211 controls access to a storage device in each of the LSIs 214-1 to 214-M and/or to a storage device in the external device 23 to thereby write data to a desired storage device or read data from a desired storage device. The bridge circuit 212 interconnects the main processor 211, the memory 213 and the LSIs 214-1 to 214-M. The memory 213 stores an error log, and the like, collected by the main processor 211. The LSIs 214-1 to 214-M may be implemented by various circuits, and the type and operation of the circuit itself are not specifically limited. Each of the LSIs 214-1 to 214-M may include, for example, a storage device, such as a memory. In addition, the LSIs 214-1 to 214-M may be differently configured circuits that are able to execute mutually different operations or may be similarly configured circuits that are able to execute similar operations. When the LSIs 214-1 to 214-M are similarly configured circuits that are able to execute similar operations, it is possible to implement a circuit portion that has a redundant configuration in the information processing device 21-1. The switch circuits 215-1 to 215-N have a function of interrupting connection between the information processing device 21-1 and the external device 23 through the external I/Fs 22, that is, connection between the information processing device 21-1 and the external I/Fs 22, and may be replaced with connection control circuits, such as repeater circuits, having a similar function.

The main processor 211 and the support processor 221 are connected through the sideband I/F 218. The sideband I/F 218 is an existing I/F provided for an existing general-purpose processor, and is normally used in relatively low-speed operations, such as setting of a control target device. In the present embodiment, the sideband I/F 218 is effectively utilized.

As standards for the sideband I/F 218, for example, I2C or I²C, Interface Integrated Circuit standardized in I2C-BUS Specification Version 2.1 by Philips Semiconductor and a generalized TWI, Two-Wire Interface, are known. The I2C operates at a relatively low-speed of 100 kHz to 400 kHz in half duplex and multidrop, and is controlled by signals transmitted through two signal lines excluding ground line of a clock (SCL: Serial Clock Line) and data (SDA: Serial Data Lines).

The support processor 221 is independent of main data buses 216 and 217, and monitors and controls these data buses 216 and 217. The support processor 221 is able to access information of the device portions inside the information processing device 21-1 that includes the main processor 211and the LSIs 214-1 to 214-M through the sideband I/F 218. The information of the device portions contains information regarding the condition of each device portion, and the like, and is stored in a register (not shown) provided in each of the device portions, so that the information of each device portion may be acquired by accessing the register. In the example shown in FIG. 2, the support processor 221 is able to access, through the sideband I/F 218, information of the main processor 211, bridge circuit 212, LSIs 214-1 to 214-M and switch circuits 215-1 to 215-N.

For example, when an abnormality including failure, or the like, occurs in the main data bus 216 or 217 shown in FIG. 2, the support processor 221 acquires information of each device portion in the information processing device 21-1 through the sideband I/F 218 and supplies an enable control signal through the control line 240 to the switch circuits 215-1 to 215-N to turn off the switch circuits 215-1 to 215-N to thereby interrupting connection with the external I/Fs 22. The enable control signal may employ the same signal as an enable control signal that is used in typical existing devices.

The data transmission rate of the sideband I/F 218 is lower than the data transmission rates of the data buses 216 and 217. In this way, by combining data buses or I/Fs having different data transmission rates in the information processing device 21-1 to perform circuit design based on characteristics, size, and the like, of data transmitted on the data buses, it is possible to implement the relatively low-cost information processing device 21-1. In addition, by appropriately combining data buses having different data transmission rates in the information processing device 21-1, it is possible to suppress propagation of error on the data buses.

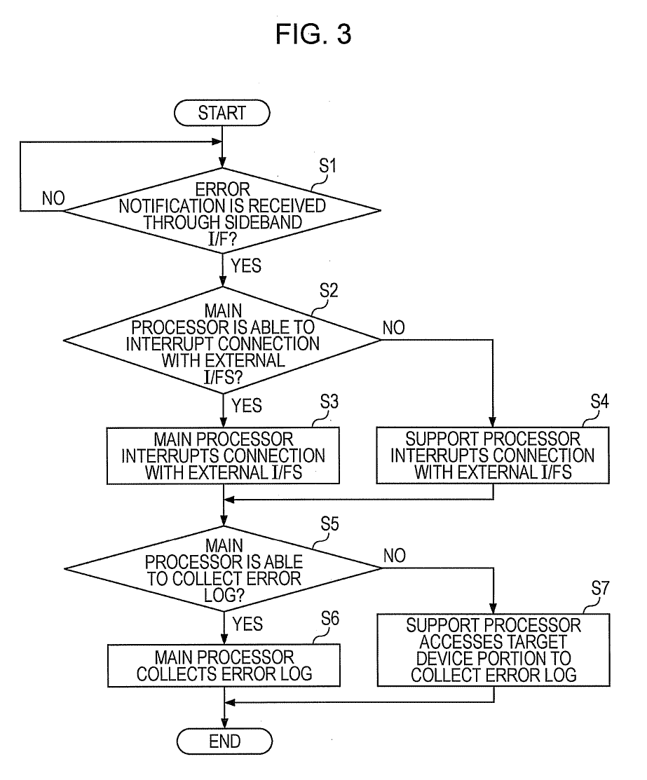

FIG. 3 is a flowchart that illustrates the operation of the support processor 221 according to the first embodiment. In FIG. 3, step S1 determines whether an error notification is received through the sideband I/F 218 from the device portions of the information processing device 21-1, and determines the type of error indicated by the received error notification. The error notification is provided when an error that influences the data bus 216 or the data buses 217 occurs, for example, due to an abnormality that occurs in the data bus 216 connecting the main processor 211 with the bridge circuit 212 or an abnormality that occurs in the data bus 217 connecting the bridge circuit 212 with each of the LSIs 214-1 to 214-M. Furthermore, the error notification is provided when an error occurs due to an abnormality of each device portion (for example, the main processor 211) itself of the information processing device 21-1.

When the result of determination is YES in step S1, step S2 determines, on the basis of the notification received through the sideband I/F 218 from the main processor 211, whether the main processor 211 is able to interrupt connection of the information processing device 21-1 with the external I/Fs 22. The notification that the support processor 221 receives from the main processor 211 contains information that indicates whether the main processor 211 is able to control the switch circuits 215-1 to 215-N to an off state.

When it is determined in step SI that the type of error is, for example, not caused by the main data bus 216 or 217 and the result of determination in step S2 is YES, step S3 permits the main processor 211 to control the switch circuits 215-1 to 215-N to an off state through the control line 240, that is, to interrupt connection of the information processing device 21-1 with the external I/Fs 22, and the support processor 221 does not control the switch circuits 215-1 to 215-N.

On the other hand, when it is determined in step S1 that the type of error is, for example, caused by the main data bus 216 or 217 and the result of determination in step S2 is NO, step S4 instructs the support processor 221 to control the switch circuits 215-1 to 215-N to an off state through the control line 240, that is, to interrupt connection of the information processing device 21-1 with the external I/Fs 22. After step S3 or S4, the process proceeds to step S5. Note that when the notification that contains information indicating whether the main processor 211 is able to control the switch circuits 215-1 to 215-N to an off state is not obtained as well, the result of determination in step S2 is, of course, NO.

Step S5 determines, on the basis of the notification received through the sideband I/F 218 from the main processor 211, whether the main processor 211 is able to collect an error log. The notification that the support processor 221 receives from the main processor 211 contains information that indicates whether the main processor 211 is able to collect an error log.

When the result of determination in step S5 is YES, step S6 permits the main processor 211 to collect an error log through the data buses 216 and/or 217 and/or the sideband I/F 218, and the error log collected by the main processor 211 accessing a target device portion in the information processing device 21-1 is stored in the memory 213. Normally, because the main processor 211 is able to collect information containing a more detailed error log than the support processor 221, the main processor 211 collects an error log as in the case of other failures when the main processor 211 is able to collect an error log. On the other hand, when the result of determination in step S5 is NO, step S7 collects an error log in such a manner that the support processor 221 accesses the target device portion in the information processing device 21-1 through the sideband I/F 218, and the collected error log is stored in the memory 223. After step S6 or S7, the process ends. The error log contains information including error factors.

In this way, according to the present embodiment, owing to the sideband I/F 218, even when an error occurs, for example, due to an abnormality of the main data bus 216 or 217, registers of almost all the device portions in the information processing device 21-1 may be accessed through the sideband I/F 218. Thus, it is possible to isolate error factors by reliably collecting error conditions due to an abnormality.

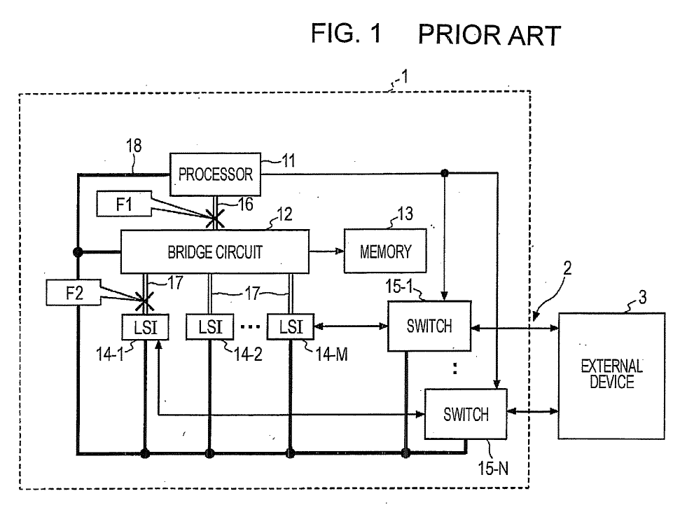

Incidentally, in the example of an existing art shown in FIG. 1, after an error occurs due to the main data bus 16 or 17 connected to the main processor 11, it is possible that invalid data, such as collapsed data or erroneous data, are output through the external I/Fs 2 or, despite a state in which an error is occurring in the information processing device 1, the information processing device 1 responds to a request from the external device 3. In addition, when an error that influences the main data bus 16 or 17 occurs, it is possible that, if communication with the external device 3 is not disconnected quickly, erroneous data, or the like, are output to the external device 3 to thereby adversely affect, for example, the entire storage system.

In contrast, in the present embodiment, when an abnormality occurs, for example, in the main data bus 216 or 217, connection of the information processing device 21-1 with the external I/Fs 22 is interrupted. Thus, it is possible to reliably prevent invalid data from being output through the external I/Fs 22 or, despite a state in which an error is occurring in the information processing device 21-1, the information processing device 21-1 responds to a request from the external device 23.

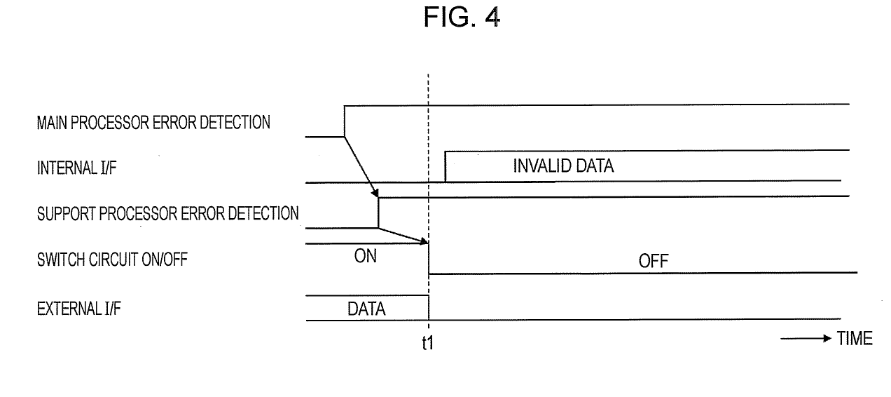

FIG. 4 is a time chart that illustrates the operation of the present embodiment. FIG. 4 shows timing at which the main processor 211 detects an error in the information processing device 21-1, invalid data transmitted through the internal I/F 219 after occurrence of an error, timing at which the support processor 221 detects an error in the information processing device 21-1, timing at which the switch circuits 215-1 to 215-N are turned on/off by the support processor 221, and data transmitted through the external I/Fs 22. As shown in FIG. 4, the support processor 221 detects an error and then controls the switch circuits 215-1 to 215-N to an off state, so that, even when invalid data are transmitted through the internal I/F 219, the invalid data are never output to the external device 23 through the external I/Fs 22 because of the interrupted connection of the information processing device 21-1 with the external I/Fs 22. In addition, because connection of the information processing device 21-1 with the external I/Fs 22 is interrupted, the information processing device 21-1 will not respond to a request from the external device 23.

In this way, in the present embodiment, because the sideband I/F 218 is used, it is not necessary to execute bus reset for acquiring error information, and information regarding a state of device portions, such as the LSIs 214-1 to 214-M, is not reset through the bus reset, it is possible to reliably acquire information regarding a state of the device portions, including error information. Furthermore, according to the present embodiment, without outputting invalid data through the external I/Fs 22 or an unnecessary response to request from the external device 23, it is possible to reliably acquire an error log that contains information including error factors. For this reason, it is possible to improve reliability of data, it is easy to analyze data when an error occurs, and it is possible to improve reliability of the information processing device 21-1 and, for example, the entire storage system.

### Second Embodiment

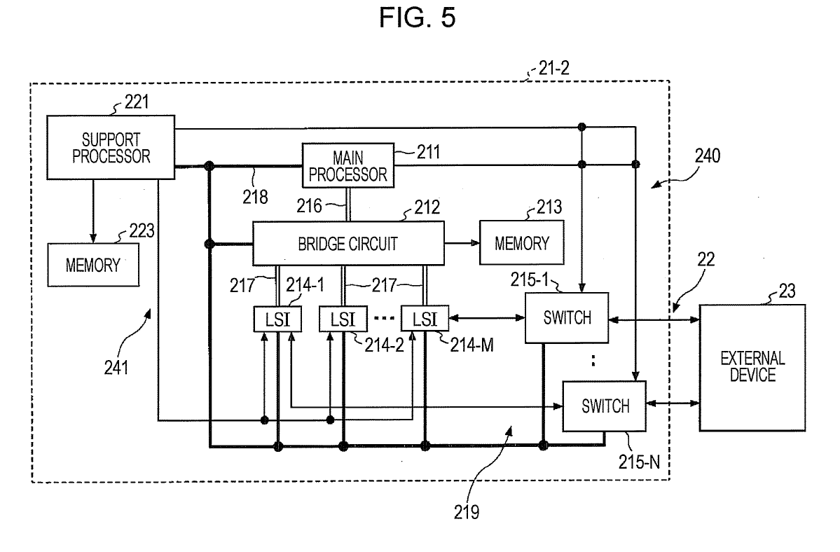

FIG. 5 is a block diagram that shows a second embodiment of the invention. In FIG. 5, similar components to those of FIG. 2 are assigned with the same reference numerals, and the description thereof is omitted.

In the present embodiment, the support processor 221 of an information processing device 21-2 outputs, through a signal line 241, a control signal that controls the LSIs 214-1 to 214-M to an enable state or a disable state at the same time. Thus, when the support processor 221 executes the operation shown in FIG. 3, in step S4, in addition to the control that makes the external I/Fs 22 be in a disable state, the support processor 221 control the LSIs 214-1 to 214-M to enter a disable state at the same time. In this way, by controlling the LSIs 214-1 to 214-M to a disable state as well, it is possible to further reliably prevent output of invalid data to the external device 23 and an necessary response to a request from the external device 23. In addition, it is possible to prevent the LSIs 214-1 to 214-M from erroneously controlling the bridge circuit 212.

According to the present embodiment, in comparison with the first embodiment, it is possible to further improve reliability of data, it is easy to analyze data when an error occurs, and it is further easy to analyze data when an error occurs, and it is possible to further improve reliability of the information processing device 21-1 and, for example, the entire storage system.

### Third Embodiment

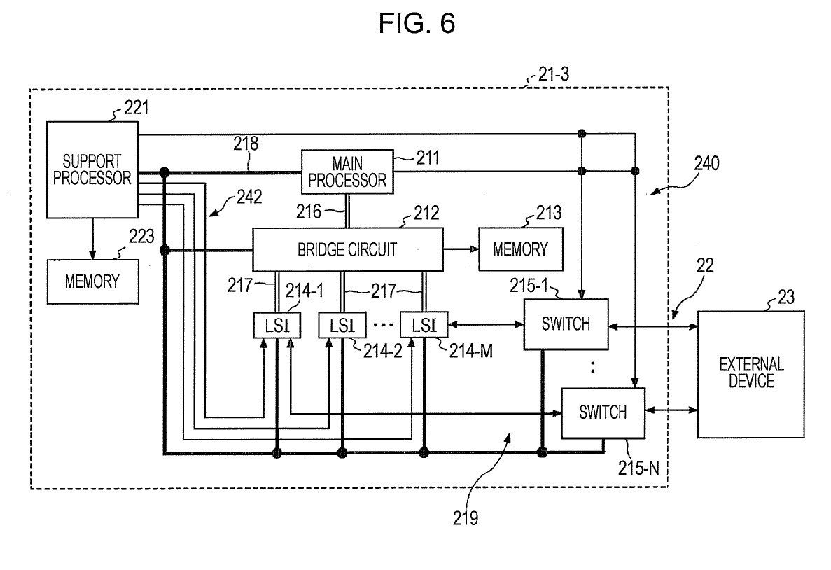

FIG. 6 is a block diagram that shows a third embodiment of the invention. In FIG. 5, similar components to those of FIG. 2 are assigned with the same reference numerals, and the description thereof is omitted.

In the present embodiment, the support processor 221 of an information processing device 21-3 outputs, through a signal line 242, a control signal that controls the LSIs 214-1 to 214-M to an enable state or a disable state separately. Thus, when the support processor 221 executes the operation shown in FIG. 3, in step S4, in addition to the control that makes the external I/Fs 22 be in a disable state, the support processor 221 control the LSIs 214-1 to 214-M to enter a disable state separately.

For example, when an abnormality occurs in the main data buses 217 between the bridge circuit 212 and the LSIs 214-1 to 214-M, only the switch circuit 215 and LSI 214 inserted in the external I/F 22 corresponding to the main data bus 217 in which the abnormality occurs are controlled to enter a disable state to thereby interrupt only the external I/F 22 of the data bus 217, in which the abnormality has occurred, from the information processing device 21-3. However, the switch circuits 215 and the LSIs 214 that are inserted in the external I/Fs 22 corresponding to the normal data buses 217 in which no abnormality is occurring are used continuously. That is, operation of only a normal system is enabled that is activated and operation of an abnormal system, in which an abnormality has occurred, is stopped that is deactivated, so that it is possible to suppress the range of the external I/Fs 22 being interrupted from the information processing device 21-3 to a minimum. Thus, the performance of the information processing device 21-3 and, for example, storage system somewhat decreases, but the worst-case scenario, that is, system failure, may be prevented. Furthermore, by preventing malfunction of the LSI 214 due to a disabled switch circuit 215, or the like, it is possible to establish communication between the information processing device 21-3 and the external device 23 using only the effective external I/Fs 22.

In this way, by controlling the LSIs 214-1 to 214-M separately to a disable state as well, without occurrence of system failure, it is possible to reliably prevent output of invalid data to the external device 23 and an unnecessary response to a request from the external device 23. In addition, it is possible to prevent the LSIs 214-1 to 214-M from erroneously controlling the bridge circuit 212.

According to the present embodiment, in comparison with the first embodiment, it is possible to further improve reliability of data, it is easy to analyze data when an error occurs, and it is further easy to analyze data when an error occurs, and it is possible to further improve reliability of the information processing device 21-1 and, for example, the entire storage system. Furthermore, by stopping operation of only an abnormal system and maintaining operation of a normal system, it is possible to prevent system failure.

All examples and conditional language recited herein are intended for pedagogical purposes to aid the reader in understanding the invention and the concepts contributed by the inventor to furthering the art, and are to be construed as being without limitation to such specifically recited examples and condition, nor does the organization of such examples in the specification relate to a showing of superiority and inferiority of the invention. Although the embodiment of the present inventions have been described in detail, it should be understood that the various changes, substitutions, and alternations could be made hereto without departing from the spirit and scope of the invention.

What is claimed is:

1. A control method for controlling an information processing device including a first processor, a second processor, and a plurality of devices, comprising the steps of:
detecting an error of at least one device of the plurality of devices by the first processor;
storing an error log related to the detected error in the devices in a memory by the first processor;
when failing in store the error log in the memory, storing the error log in an auxiliary memory by the second processor.

2. The control method according to claim 1, further comprising the steps of:
generating the error log related to the detected error in the devices by the first processor.

3. The control method according to claim 1, further comprising the steps of:
controlling connection of the information processing device with an external device by the second processor on the basis of the error detection.

4. The control method according to claim 3, further comprising the steps of:
controlling connection of the external device with the information processing device which is influenced by the error by the second processor on the basis of the error detection.

5. The control method according to claim 1, further comprising the steps of:
stopping operation of the device by the second processor on the basis of the error detection.

6. The control method according to claim 5, further comprising the steps of:
stopping operation of the device which is influenced by the error by the second processor on the basis of the error detection.

7. The control method according to claim 1, wherein the step of acquiring the error log by the second processor is performed when the first processor cannot store the error log in the memory.

8. An information processing device comprising:
a first processor;
a second processor; and
a plurality of devices electrically connected to the first processor and the second processor; and
wherein the first processor detects an error of at least one device of the plurality of devices, stores an error log related to the detected error in the devices in a memory, and when the first processor fails in store the error log in the memory, the second processor stores the error log in an auxiliary memory.

9. The information processing device according to claim 8, further comprising:
a connection control circuit for connecting the information processing device with an external device on the basis of the error detection.

10. The information processing device according to claim 9, wherein the second processor controls connection of the external device with the device influenced by error by controlling the connection control circuit on the basis of the error detection.

11. The information processing device according to claim 8, wherein the second processor stops operation of the device on the basis of the error detection.

12. The information processing device according to claim 11, wherein the second processor stops operation of only the device portion which is influenced by the error on the basis of the error detection.

13. The information processing device according to claim 8, wherein the second processor acquires the error log when the first processor cannot store the error log in the memory.
